(19) United States
(12) Patent Application Publication
(10) Pub. No.: US 2026/0009999 A1
(43) Pub. Date: Jan. 8, 2026

(54) OPTICAL SCANNING DEVICE, IMAGE DRAWING SYSTEM, AND DRIVING METHOD OF MIRROR DEVICE

(71) Applicant: FUJIFILM Corporation, Tokyo (JP)

(72) Inventors: Shinichiro SONODA, Kanagawa (JP); Hirotoshi YOSHIZAWA, Kanagawa (JP); Nobuya TANAKA, Kanagawa (JP)

(73) Assignee: FUJIFILM Corporation, Tokyo (JP)

(21) Appl. No.: 19/322,948

(22) Filed: Sep. 9, 2025

Related U.S. Application Data
(63) Continuation of application No. PCT/JP2024/007098, filed on Feb. 27, 2024.

(30) Foreign Application Priority Data
Mar. 27, 2023 (JP) 2023-050622

(51) Int. Cl. G02B 26/10; G02B 7/18; G02B 26/08

(52) U.S. Cl. CPC G02B 26/101; G02B 7/181; G02B 26/0858

(57) ABSTRACT

A driving controller applies a first driving signal having a first driving frequency to a pair of first actuators, applies a second driving signal having a second driving frequency to a pair of second actuators, and changes the second driving frequency such that a delay phase difference of a second sensor signal relative to the second driving signal is brought closer to a reference value while maintaining a frequency ratio, which is a ratio between the first driving frequency and the second driving frequency, at a constant value.

### CROSS-REFERENCE TO RELATED APPLICATIONS

This application is a continuation application of International Application No. PCT/JP2024/007098, filed Feb. 27, 2024, the disclosure of which is incorporated herein by reference in its entirety. Further, this application claims priority from Japanese Patent Application No. 2023-050622, filed on Mar. 27, 2023, the disclosure of which is incorporated herein by reference in its entirety.

### BACKGROUND

### 1. Technical Field

The present disclosure relates to an optical scanning device, an image drawing system, and a driving method of a mirror device.

### 2. Description of the Related Art

A micromirror device (also referred to as a microscanner) has been known as one of micro electro mechanical systems (MEMS) devices manufactured using a silicon (Si) nanofabrication technology. Since an optical scanning device comprising the micromirror device has a small size and has low power consumption, it is expected to have a range of applications in an image drawing system such as a laser display or a laser projector.

The micromirror device has a mirror portion that is formed to be capable of swinging around a first axis and a second axis that are orthogonal to each other, and, as the mirror portion swings around each axis, light reflected by the mirror portion is two-dimensionally scanned. In addition, a micromirror device that can perform Lissajous scanning of light by causing a mirror portion to resonate around each axis has been known.

JP2016-184018A discloses a technology of, in a micromirror device that causes a mirror portion to swing around a first axis and a second axis, selecting a driving frequency and a frame rate based on an amplitude and a phase of the mirror portion.

### SUMMARY

In order to reduce driving power of the micromirror device, it is preferable that a frequency of a first driving signal for causing the mirror portion to swing around the first axis (hereinafter, referred to as a “first driving frequency”) is a value close to a resonance frequency of the mirror portion around the first axis (hereinafter, referred to as a “first resonance frequency”). Similarly, it is preferable that a frequency of a second driving signal for causing the mirror portion to swing around the second axis (hereinafter, referred to as a “second driving frequency”) is a value close to a resonance frequency of the mirror portion around the second axis (hereinafter, referred to as a “second resonance frequency”). The first resonance frequency and the second resonance frequency fluctuate due to a temperature change or the like. Therefore, it is preferable to change the first driving frequency and the second driving frequency in response to the fluctuation in the first resonance frequency and the fluctuation in the second resonance frequency, respectively.

On the other hand, in order to cause the mirror portion to perform Lissajous scanning at a desired scanning density (that is, a drawing resolution), it is necessary to maintain a ratio (hereinafter, referred to as a “frequency ratio”) between the first driving frequency and the second driving frequency at a constant value. However, JP2016-184018A discloses selecting the driving frequency and the frame rate based on a resonance frequency predicted from a phase, but does not disclose maintaining the frequency ratio at a constant value.

Since the first resonance frequency and the second resonance frequency fluctuate independently, it is difficult to change the first driving frequency and the second driving frequency in response to the fluctuation in the first resonance frequency and the fluctuation in the second resonance frequency, respectively, while maintaining the frequency ratio at a constant value. In a case where the amount of deviation of the first driving frequency from the first resonance frequency increases, the maximum deflection angle of the mirror portion around the first axis decreases. Similarly, in a case where the amount of deviation of the second driving frequency from the second resonance frequency increases, the maximum deflection angle of the mirror portion around the second axis decreases. Therefore, there is a demand for a technology that makes it possible to suppress a decrease in the maximum deflection angle while maintaining the frequency ratio at a constant value in a case of performing Lissajous scanning.

An object of the technology of the present disclosure is to provide an optical scanning device, an image drawing system, and a driving method of a mirror device that are capable of suppressing a decrease in the maximum deflection angle while maintaining a frequency ratio at a constant value.

In order to achieve the above object, according to the present disclosure, there is provided an optical scanning device comprising: a mirror portion that reflects an incidence ray; a pair of first actuators that causes the mirror portion to swing around a first axis; a pair of second actuators that causes the mirror portion to swing around a second axis intersecting the first axis; a first angle detection sensor that outputs a first sensor signal corresponding to a deflection angle of the mirror portion around the first axis; a second angle detection sensor that outputs a second sensor signal corresponding to a deflection angle of the mirror portion around the second axis; and a processor that applies a first driving signal having a first driving frequency to the pair of first actuators and applies a second driving signal having a second driving frequency to the pair of second actuators, in which the processor changes the second driving frequency such that a delay phase difference of the second sensor signal relative to the second driving signal is brought closer to a reference value while maintaining a frequency ratio, which is a ratio between the first driving frequency and the second driving frequency, at a constant value.

It is preferable that the processor determines a value of the second driving frequency such that the delay phase difference is brought closer to the reference value, determines a value of the first driving frequency based on the determined value of the second driving frequency and the frequency ratio, and changes the first driving frequency and the second driving frequency to the respective determined values.

It is preferable that the second driving frequency is lower than the first driving frequency.

It is preferable that a frequency bandwidth of the deflection angle around the second axis with respect to the second driving frequency is narrower than a frequency bandwidth of the deflection angle around the first axis for the first driving frequency.

It is preferable that the reference value is 90°.

It is preferable that the optical scanning device further comprises: a temperature sensor that detects an environmental temperature and outputs a detected value, and the processor corrects an amplitude voltage of the first driving signal and an amplitude voltage of the second driving signal based on the detected value.

According to the present disclosure, there is provided an image drawing system comprising: the optical scanning device according to any one of the above aspects; and a light source that irradiates the mirror portion with a light beam.

According to the present disclosure, there is provided a driving method of a mirror device that includes a mirror portion that reflects an incidence ray, a pair of first actuators that causes the mirror portion to swing around a first axis, a pair of second actuators that causes the mirror portion to swing around a second axis intersecting the first axis, a first angle detection sensor that outputs a first sensor signal corresponding to a deflection angle of the mirror portion around the first axis, and a second angle detection sensor that outputs a second sensor signal corresponding to a deflection angle of the mirror portion around the second axis, the driving method comprising: causing a processor to apply a first driving signal having a first driving frequency to the pair of first actuators, apply a second driving signal having a second driving frequency to the pair of second actuators, and change the second driving frequency such that a delay phase difference of the second sensor signal relative to the second driving signal is brought closer to a reference value while maintaining a frequency ratio, which is a ratio between the first driving frequency and the second driving frequency, at a constant value.

According to the technology of the present disclosure, it is possible to suppress a decrease in the maximum deflection angle while maintaining the frequency ratio at a constant value.

### BRIEF DESCRIPTION OF THE DRAWINGS

Exemplary embodiments according to the technique of the present disclosure will be described in detail based on the following figures, wherein:

FIG. 1 is a schematic diagram of an image drawing system according to a first embodiment,

FIG. 2 is an external perspective view of a micromirror device,

FIG. 3 is a graph showing an example of a first driving signal and a second driving signal,

FIG. 4 is a block diagram showing an example of a functional configuration of a driving controller according to the first embodiment,

FIG. 5 is a diagram showing an example of a first sensor signal output from a first angle detection sensor,

FIG. 6 is a diagram showing an example of a second sensor signal output from a second angle detection sensor,

FIG. 7 is a diagram showing an example of first signal processing,

FIG. 8 is a diagram showing an example of second signal processing,

FIG. 9 is a diagram illustrating a process of generating a first zero cross pulse,

FIG. 10 is a diagram illustrating a process of generating a second zero cross pulse,

FIG. 11 is a diagram showing an example of frequency characteristics of a mirror portion around a first axis,

FIG. 12 is a diagram showing an example of frequency characteristics of the mirror portion around a second axis,

FIG. 13 is a diagram conceptually showing delay phase difference control in a case where an environmental temperature is decreased,

FIG. 14 is a diagram showing an example of a flow of the delay phase difference control,

FIGS. 15A and 15B are diagrams showing results of Experiment 1,

FIGS. 16A and 16B are diagrams showing results of Experiment 2,

FIGS. 17A and 17B are diagrams showing results of Experiment 3,

FIG. 18 is a schematic diagram of an image drawing system according to a second embodiment,

FIG. 19 is a block diagram showing an example of a functional configuration of a driving controller according to the second embodiment,

FIGS. 20A and 20B are diagrams showing results of Experiment 4,

FIGS. 21A and 21B are diagrams showing results of Experiment 5, and

FIGS. 22A and 22B are diagrams showing results of Experiment 6.

FIG. 23 is a plan view of a micromirror device according to a modification example.

### DETAILED DESCRIPTION

Hereinafter, an embodiment for carrying out the technology of the present disclosure will be described in detail with reference to the drawings.

### First Embodiment

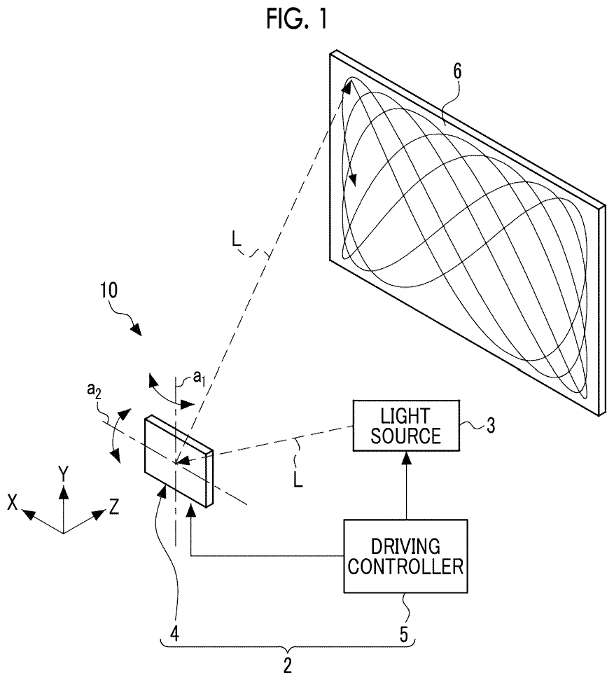

First, a configuration of an image drawing system 10 according to a first embodiment will be described with reference to FIG. 1. As shown in FIG. 1, the image drawing system 10 comprises an optical scanning device 2 and a light source 3. The optical scanning device 2 comprises a micromirror device (hereinafter, referred to as an “MMD”) 4 and a driving controller 5. The driving controller 5 is an example of a “processor” according to the technology of the present disclosure. The MMD 4 is an example of a “mirror device” according to the technology of the present disclosure.

The image drawing system 10 draws an image by reflecting a light beam L emitted from the light source 3 by the MMD 4 and optically scanning a surface to be scanned 6 with the reflected light beam under the control of the driving controller 5. The surface to be scanned 6 is, for example, a screen for projecting the image, or a retina of an eye of a person.

The image drawing system 10 is applied to, for example, a Lissajous scanning type laser display. Specifically, the image drawing system 10 can be applied to a laser scanning display such as augmented reality (AR) glasses or virtual reality (VR) glasses.

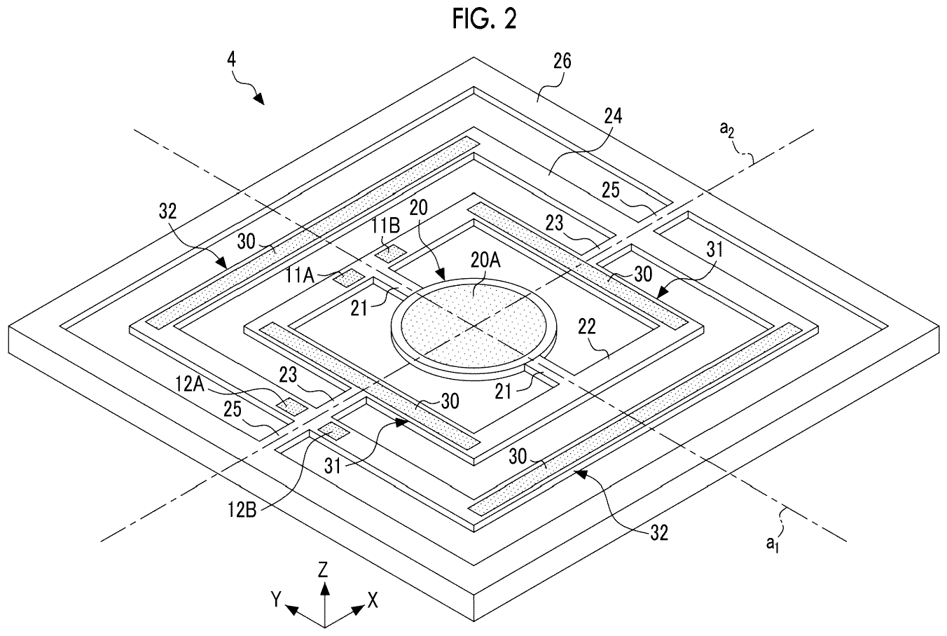

The MMD 4 is a piezoelectric biaxial drive type micromirror device capable of causing a mirror portion 20 (see FIG. 2) to swing around a first axis a₁ and around a second axis a₂ orthogonal to the first axis a₁. Hereinafter, a direction parallel to the second axis a₂ will be referred to as an X direction, a direction parallel to the first axis a₁ will be referred to as a Y direction, and a direction orthogonal to the first axis a₁ and to the second axis a₂ will be referred to as a Z direction. In the present embodiment, an example in which the first axis a₁ is orthogonal to (that is, perpendicularly intersects with) the second axis a₂ is shown, but the first axis a₁ may intersect with the second axis a₂ at an angle other than 90°. Here, the intersection refers to an intersection within a certain angle range including an allowable error, centered on 90°.

The light source 3 is a laser device that emits, for example, laser light as the light beam L. For example, the light source 3 outputs laser light of three colors of red (R), green (G), and blue (B). It is preferable that the light source 3 emits the light beam L perpendicularly to a reflecting surface 20A (see FIG. 2) included in the mirror portion 20 in a state where the mirror portion 20 of the MMD 4 is stationary. In a case where the light beam Lis emitted from the light source 3 perpendicularly to the reflecting surface 20A, the light source 3 may become an obstacle in scanning the surface to be scanned 6 with the light beam L for drawing. Therefore, it is preferable that the light beam L emitted from the light source 3 is controlled by an optical system such as a beam splitter to be emitted perpendicularly to the reflecting surface 20A. The optical system may include a lens or may not include a lens. In addition, an angle at which the light beam L emitted from the light source 3 is applied onto the reflecting surface 20A is not limited to a perpendicular angle, and the light beam L may be applied obliquely onto the reflecting surface 20A.

The driving controller 5 outputs a driving signal to the light source 3 and the MMD 4 based on optical scanning information. The light source 3 generates the light beam L based on the input driving signal and emits the light beam L to the MMD 4. The MMD 4 causes the mirror portion 20 to swing around the first axis a₁ and the second axis a₂ based on the input driving signal.

The driving controller 5 causes the mirror portion 20 to resonate around the first axis a₁ and the second axis a₂, so that the surface to be scanned 6 is scanned with the light beam L reflected by the mirror portion 20 such that a Lissajous waveform is drawn. This optical scanning method is called a Lissajous scanning method.

Next, a configuration of the MMD 4 according to the present embodiment will be described with reference to FIG. 2. As shown in FIG. 2, the MMD 4 includes the mirror portion 20, first support portions 21, a first movable frame 22, second support portions 23, a second movable frame 24, connecting portions 25, and a fixed frame 26. The MMD 4 is a so-called MEMS scanner.

The mirror portion 20 has the reflecting surface 20A that reflects an incidence ray. The reflecting surface 20A is provided on one surface of the mirror portion 20 and is formed of a thin metal film such as gold (Au), aluminum (Al), silver (Ag), or a silver alloy. The shape of the reflecting surface 20A is, for example, a circular shape centered on the intersection of the first axis a₁ and the second axis a₂.

The first axis a₁ and the second axis a₂ exist in a plane including the reflecting surface 20A in a case where the mirror portion 20 is stationary. The planar shape of the MMD 4 is rectangular, line-symmetrical with respect to the first axis a₁, and line-symmetrical with respect to the second axis a₂.

The first support portions 21 are disposed on an outside of the mirror portion 20 at positions facing each other across the second axis a₂. The first support portions 21 are connected to the mirror portion 20 on the first axis a₁, and swingably support the mirror portion 20 around the first axis a₁. In the present embodiment, the first support portion 21 is a torsion bar stretched along the first axis a₁.

The first movable frame 22 is a rectangular frame that surrounds the mirror portion 20 and is connected to the mirror portion 20 on the first axis a₁ via the first support portions 21. Piezoelectric elements 30 are formed on the first movable frame 22 at positions facing each other across the first axis a₁. In this way, a pair of first actuators 31 are configured by forming two piezoelectric elements 30 on the first movable frame 22.

The pair of first actuators 31 are disposed at positions facing each other across the first axis a₁. The pair of first actuators 31 cause the mirror portion 20 to swing around the first axis a₁ by applying rotational torque around the first axis a₁ to the mirror portion 20.

The second support portions 23 are disposed on an outside of the first movable frame 22 at positions facing each other across the first axis a₁. The second support portions 23 are connected to the first movable frame 22 on the second axis a₂ and swingably support the first movable frame 22 and the mirror portion 20 around the second axis a₂. In the present embodiment, the second support portion 23 is a torsion bar stretched along the second axis a₂.

The second movable frame 24 is a rectangular frame that surrounds the first movable frame 22 and is connected to the first movable frame 22 on the second axis a₂ via the second support portions 23. Piezoelectric elements 30 are formed on the second movable frame 24 at positions facing each other across the second axis a₂. In this way, a pair of second actuators 32 are configured by forming two piezoelectric elements 30 on the second movable frame 24.

The pair of second actuators 32 are disposed at positions facing each other across the second axis a₂. The pair of second actuators 32 cause the mirror portion 20 to swing around the second axis a₂ by applying rotational torque around the second axis a₂ to the mirror portion 20 and the first movable frame 22.

The connecting portions 25 are disposed on an outside of the second movable frame 24 at positions facing each other across the first axis a₁. The connecting portions 25 are connected to the second movable frame 24 on the second axis a₂.

The fixed frame 26 is a rectangular frame that surrounds the second movable frame 24 and is connected to the second movable frame 24 on the second axis a₂ via the connecting portions 25.

In addition, the first movable frame 22 is provided with first angle detection sensors 11A and 11B at positions facing each other across the first axis a₁ in the vicinity of the first support portion 21. Each of the first angle detection sensors 11A and 11B is composed of a piezoelectric element. Each of the first angle detection sensors 11A and 11B converts a force applied by deformation of the first support portion 21 accompanying the rotation of the mirror portion 20 around the first axis a₁ into a voltage and outputs a signal. That is, the first angle detection sensors 11A and 11B output a signal (hereinafter, referred to as a “first sensor signal”) corresponding to a deflection angle of the mirror portion 20 around the first axis a₁.

In addition, the second movable frame 24 is provided with second angle detection sensors 12A and 12B at positions facing each other across the second axis a₂ in the vicinity of the second support portion 23. Each of the second angle detection sensors 12A and 12B is composed of a piezoelectric element. Each of the second angle detection sensors 12A and 12B converts a force applied by deformation of the second support portion 23 accompanying the rotation of the mirror portion 20 around the second axis a₂ into a voltage and outputs a signal. That is, the second angle detection sensors 12A and 12B output a signal (hereinafter, referred to as a “second sensor signal”) corresponding to a deflection angle of the mirror portion 20 around the second axis a₂.

In FIG. 2, wiring lines and electrode pads for applying driving signals to the pair of first actuators 31 and the pair of second actuators 32 are not shown. In addition, in FIG. 2, wiring lines and electrode pads for outputting signals from the first angle detection sensors 11A and 11B and the second angle detection sensors 12A and 12B are not shown. A plurality of electrode pads are provided on the fixed frame 26.

A deflection angle (hereinafter, referred to as a first deflection angle) θ₁ of the mirror portion 20 around the first axis a₁ is controlled by a driving signal (hereinafter, referred to as a first driving signal) applied to the pair of first actuators 31 by the driving controller 5. The first driving signal is, for example, a sinusoidal AC voltage. The first driving signal includes a driving voltage waveform V_{1A}(t) applied to one of the pair of first actuators 31 and a driving voltage waveform V_{1B}(t) applied to the other. The driving voltage waveform V_{1A}(t) and the driving voltage waveform V_{1B}(t) are in an anti-phase with each other (that is, the phase difference is 180°).

The first deflection angle θ₁ is an angle at which a normal line of the reflecting surface 20A is inclined with respect to the Z direction in an XZ plane.

A deflection angle (hereinafter, referred to as a second deflection angle) θ₂ of the mirror portion 20 around the second axis a₂ is controlled by a driving signal (hereinafter, referred to as a second driving signal) applied to the pair of second actuators 32 by the driving controller 5. The second driving signal is, for example, a sinusoidal AC voltage. The second driving signal includes a driving voltage waveform V_{2A}(t) applied to one of the pair of second actuators 32 and a driving voltage waveform V_{2B}(t) applied to the other. The driving voltage waveform V_{2A}(t) and the driving voltage waveform V_{2B}(t) are in an anti-phase with each other (that is, the phase difference is 180°).

The second deflection angle θ₂ is an angle at which a normal line of the reflecting surface 20A is inclined with respect to the Z direction in a YZ plane.

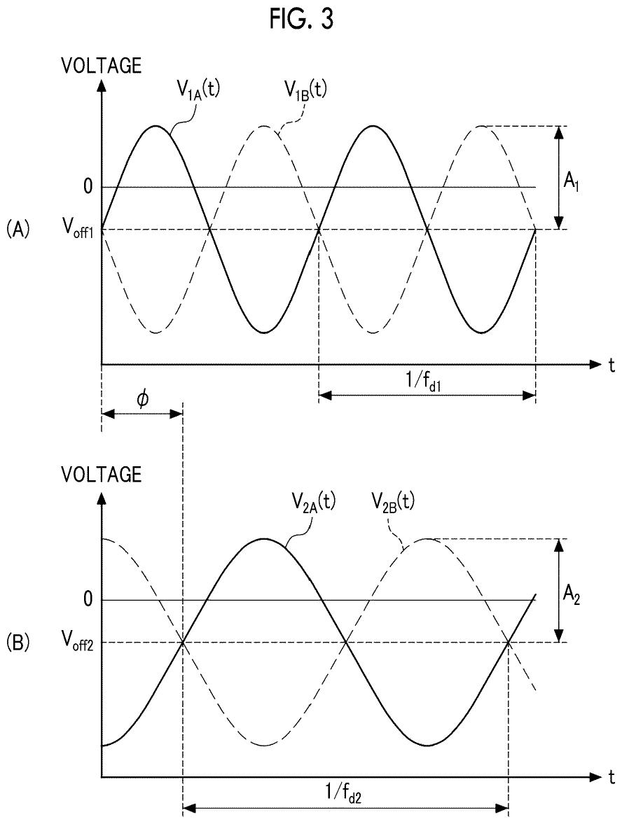

FIG. 3 shows an example of the first driving signal and the second driving signal. (A) of FIG. 3 shows the driving voltage waveforms V_{1A}(t) and V_{1B}(t) included in the first driving signal. (B) of FIG. 3 shows the driving voltage waveforms V_{2A}(t) and V_{2B}(t) included in the second driving signal.

Each of the driving voltage waveforms V_{1A}(t) and V_{1B}(t) is represented as follows.

$${V}_{1 A} ( t ) = {V}_{off 1} + {A}_{1} sin ( 2 π {f}_{d 1} t ) \\ {V}_{1 B} ( t ) = {V}_{off 1} + {A}_{1} sin ( 2 π {f}_{d 1} t + α )$$

Here, A₁ is an amplitude voltage. V_{off1} is a bias voltage. V_{off1} may be zero. In addition, f_{d1} is a driving frequency (hereinafter, referred to as a “first driving frequency”). t is time. a is a phase difference between the driving voltage waveforms V_{1A}(t) and V_{1B}(t). In the present embodiment, for example, α=180° is assumed.

By applying the driving voltage waveforms V_{1A}(t) and V_{1B}(t) to the pair of first actuators 31, the mirror portion 20 swings around the first axis a₁ at the first driving frequency f_{d1}.

Each of the driving voltage waveforms V_{2A}(t) and V_{2B}(t) is represented as follows.

$${V}_{2 A} ( t ) = {V}_{off 2} + {A}_{2} sin ( 2 π {f}_{d 2} t + φ ) \\ {V}_{2 B} ( t ) = {V}_{off 2} + {A}_{2} sin ( 2 π {f}_{d 2} t + β + φ )$$

Here, A₂ is an amplitude voltage. V_{off2} is a bias voltage. V_{off2} may be zero. In addition, f_{d2} is a driving frequency (hereinafter, referred to as a “second driving frequency”). t is time. β is a phase difference between the driving voltage waveforms V_{2A}(t) and V_{2B}(t). In the present embodiment, for example, β=180° is assumed. In addition, φ is a phase difference between the driving voltage waveforms V_{1A}(t) and V_{1B}(t) and the driving voltage waveforms V_{2A}(t) and V_{2B}(t).

By applying the driving voltage waveforms V_{2A}(t) and V_{2B}(t) to the pair of second actuators 32, the mirror portion 20 swings around the second axis a₂ at the second driving frequency f_{d2}. Hereinafter, a resonance frequency of the mirror portion 20 around the first axis a₁ will be referred to as a “first resonance frequency”, and a resonance frequency of the mirror portion 20 around the second axis a₂ will be referred to as a “second resonance frequency”.

In the present embodiment, f_{d1}>f_{d2} is assumed. That is, the mirror portion 20 has a higher swing frequency around the first axis a₁ than a swing frequency around the second axis a₂. A Lissajous waveform of the light beam L scanned on the surface to be scanned 6 by the swing of the mirror portion 20 is determined by a ratio (hereinafter, referred to as a frequency ratio) H between the first driving frequency f_{d1} and the second driving frequency f_{d2} and a phase difference φ. The frequency ratio H is, for example, H=f_{d1}/f_{d2}, and is a value set based on a desired scanning density of the light beam L.

In the mirror portion 20, in a case where the first driving frequency f_{d1} is set to the first resonance frequency, the maximum value of the first deflection angle θ₁ (hereinafter, referred to as a “first maximum deflection angle θ₁ₘₐₓ”) reaches its largest value, and, in a case where the second driving frequency f_{d2} is set, the maximum value of the second deflection angle θ₂ (hereinafter, referred to as a “second maximum deflection angle θ₂ₘₐₓ”) reaches its largest value. Here, the first maximum deflection angle θ₁ₘₐₓ and the second maximum deflection angle θ₂ₘₐₓ are defined as full angles.

In order to suppress a decrease in the first maximum deflection angle θ₁ₘₐₓ and the second maximum deflection angle θ₂ₘₐₓ, it is preferable that the first driving frequency f_{d1} and the second driving frequency f_{d2} are set to values close to the first resonance frequency and the second resonance frequency, respectively. For example, it is preferable that the first driving frequency f_{d1} and the second driving frequency f_{d2} are frequencies within a frequency range in the vicinity of the first resonance frequency and the second resonance frequency (for example, a range of half-width of a frequency distribution having the resonance frequency as a peak value). This frequency range is, for example, within a range of a so-called Q-value.

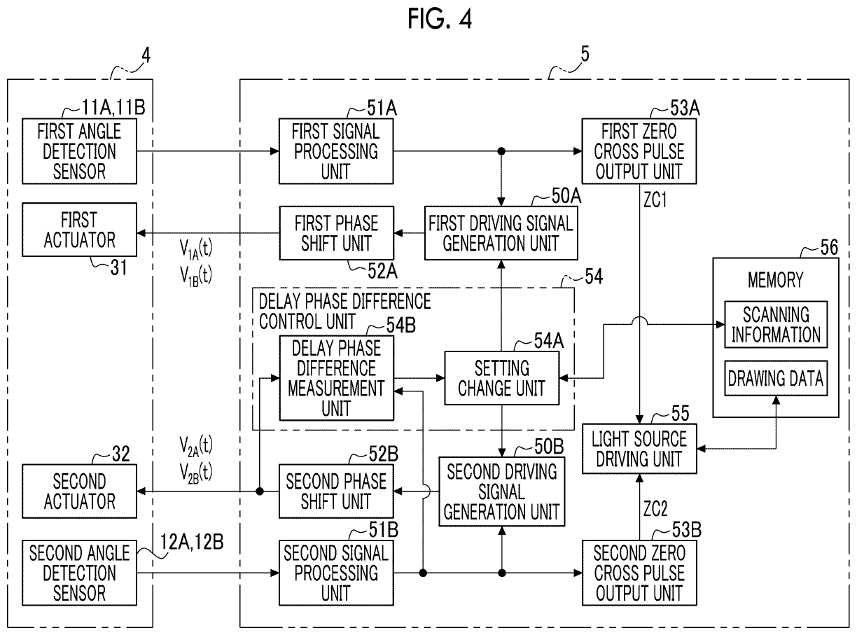

Next, a functional configuration of the driving controller 5 will be described with reference to FIG. 4. As shown in FIG. 4, the driving controller 5 includes a first driving signal generation unit 50A, a second driving signal generation unit 50B, a first signal processing unit 51A, a second signal processing unit 51B, a first phase shift unit 52A, a second phase shift unit 52B, a first zero cross pulse output unit 53A, a second zero cross pulse output unit 53B, a delay phase difference control unit 54, a light source driving unit 55, and a memory 56.

The first driving signal generation unit 50A, the first signal processing unit 51A, and the first phase shift unit 52A may perform feedback control such that a vibration state where the swing of the mirror portion 20 around the first axis a₁ maintains a swing state at a constant frequency. The second driving signal generation unit 50B, the second signal processing unit 51B, and the second phase shift unit 52B may perform feedback control such that a vibration state where the swing of the mirror portion 20 around the second axis a₂ maintains a swing state at a constant frequency.

The first driving signal generation unit 50A generates the first driving signal including the above-described driving voltage waveforms V_{1A}(t) and V_{1B}(t) based on a reference waveform, and applies the generated first driving signal to the pair of first actuators 31 via the first phase shift unit 52A. Thereby, the mirror portion 20 swings around the first axis a₁.

The second driving signal generation unit 50B generates the second driving signal including the above-described driving voltage waveforms V_{2A}(t) and V_{2B}(t) based on a reference waveform, and applies the generated second driving signal to the pair of second actuators 32 via the second phase shift unit 52B. Thereby, the mirror portion 20 swings around the second axis a₂.

The first driving signal generated by the first driving signal generation unit 50A and the second driving signal generated by the second driving signal generation unit 50B are phase-synchronized to have the above-described phase difference φ.

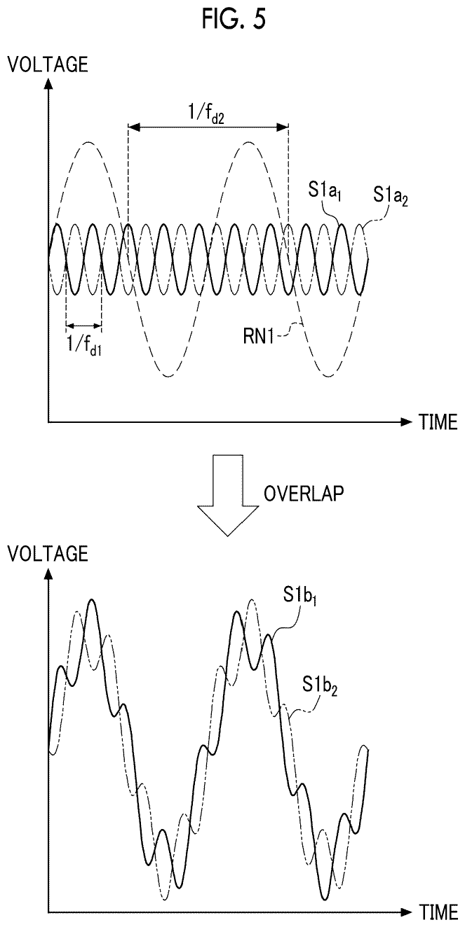

FIG. 5 shows an example of first sensor signals output from the first angle detection sensors 11A and 11B. In FIG. 5, S1a₁ and S1a₂ represent first sensor signals output from the first angle detection sensors 11A and 11B in a case where the mirror portion 20 swings only around the first axis a₁ without swinging around the second axis a₂. The signals S1a₁ and S1a₂ are waveform signals similar to a sinusoidal wave having the first driving frequency f_{d1} and are in an anti-phase with each other.

In a case where the mirror portion 20 swings around the first axis a₁ and the second axis a₂ simultaneously, a vibration noise RN1 caused by the swing of the mirror portion 20 around the second axis a₂ is superimposed on the first sensor signal. S1b₁ represents a signal after the vibration noise RN1 is superimposed on the signal S1a₁. S1b₂ represents a signal after the vibration noise RN1 is superimposed on the signal S1a₂. In FIG. 5, the vibration noise RN1 is emphasized for the purpose of describing the present embodiment.

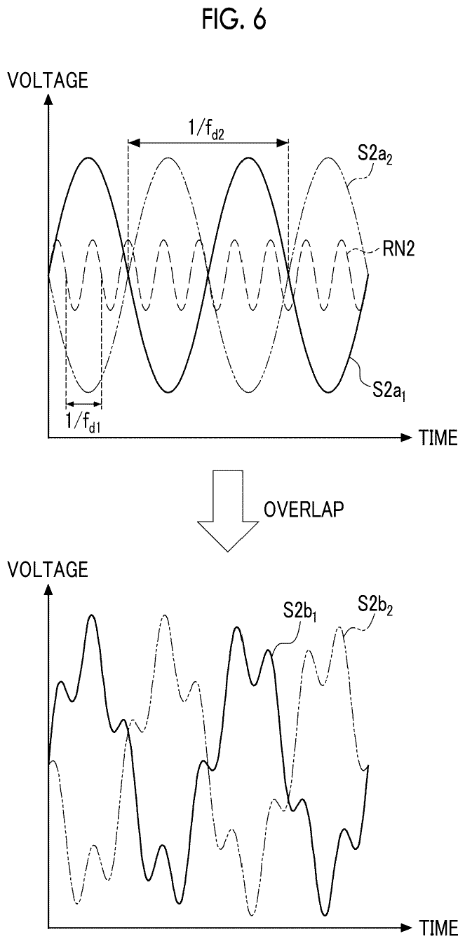

FIG. 6 shows an example of second sensor signals output from the second angle detection sensors 12A and 12B. In FIG. 6, S2a₁ and S2a₂ represent signals output from the second angle detection sensors 12A and 12B in a case where the mirror portion 20 swings only around the second axis a₂ without swinging around the first axis a₁. The signals S2a₁ and S2a₂ are waveform signals similar to a sinusoidal wave having the second driving frequency f_{d2} and are in an anti-phase with each other.

In a case where the mirror portion 20 swings around the first axis a₁ and the second axis a₂ simultaneously, a vibration noise RN2 caused by the swing of the mirror portion 20 around the first axis a₁ is superimposed on the second sensor signal. S2b₁ represents a signal after the vibration noise RN2 is superimposed on the signal S2a₁. S2b₂ represents a signal after the vibration noise RN2 is superimposed on the signal S2a₂. In FIG. 6, the vibration noise RN2 is emphasized for the purpose of describing the present embodiment.

The first signal processing unit 51A generates a signal from which the vibration noise is removed (hereinafter, referred to as a “first angle detection signal”) based on the first sensor signals output from the first angle detection sensors 11A and 11B. For example, the first signal processing unit 51A generates the first angle detection signal by subtracting the signal output from the first angle detection sensor 11B from the signal output from the first angle detection sensor 11A.

The second signal processing unit 51B generates a signal from which the vibration noise is removed (hereinafter, referred to as a “second angle detection signal”) based on the second sensor signals output from the second angle detection sensors 12A and 12B. For example, the second signal processing unit 51B generates the second angle detection signal by subtracting the signal output from the second angle detection sensor 12B from the signal output from the second angle detection sensor 12A.

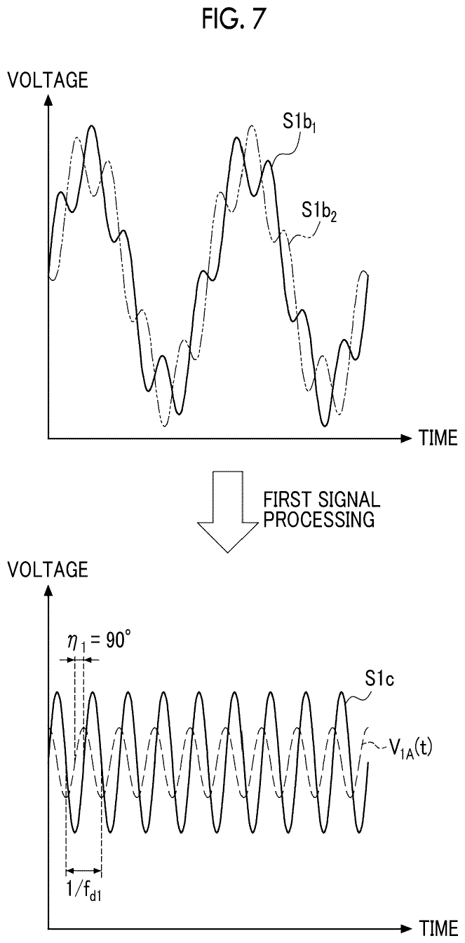

FIG. 7 shows a state in which a first angle detection signal S1c is generated based on the first sensor signals S1b₁ and S1b₂ output from the first angle detection sensors 11A and 11B. The first angle detection signal S1c corresponds to a signal obtained by doubling an amplitude of a signal obtained by removing the vibration noise RN1 from the signal S1b₁.

In a case where the swing of the mirror portion 20 around the first axis a₁ maintains a resonance state, as shown in FIG. 7, the first angle detection signal S1c output from the first signal processing unit 51A is delayed with respect to the driving voltage waveform V_{1A}(t) included in the first driving signal, and a phase difference η₁ between the first angle detection signal S1c and the driving voltage waveform V_{1A}(t) is 90°. The phase difference η₁ is a delay phase difference of the first sensor signal relative to the first driving signal. Hereinafter, the phase difference η₁ will be referred to as a “first delay phase difference η₁”.

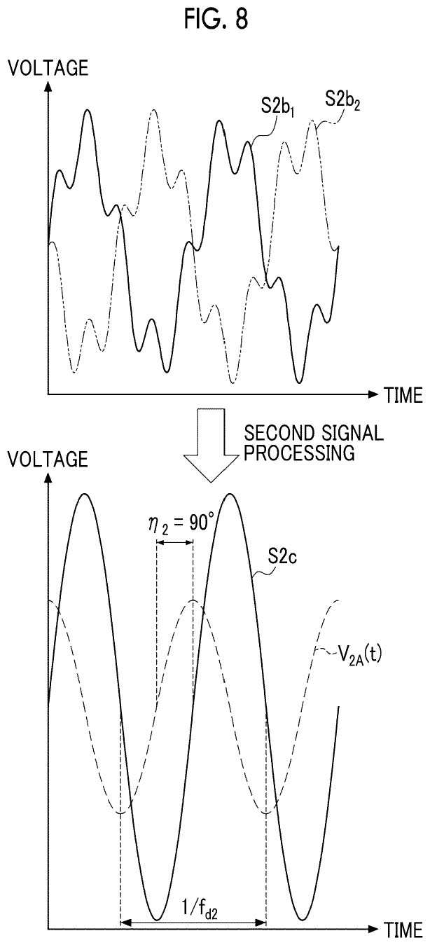

FIG. 8 shows a state in which a second angle detection signal S2c is generated based on the second sensor signals S2b₁ and S2b₂ output from the second angle detection sensors 12A and 12B. The second angle detection signal S2c corresponds to a signal obtained by doubling an amplitude of a signal obtained by removing the vibration noise RN2 from the signal S2b₁.

In a case where the swing of the mirror portion 20 around the second axis a₂ maintains a resonance state, as shown in FIG. 8, the second angle detection signal S2c output from the second signal processing unit 51B is delayed with respect to the driving voltage waveform V_{2A}(t) included in the second driving signal, and a phase difference 12 between the second angle detection signal S2c and the driving voltage waveform V_{2A}(t) is 90°. The phase difference η₂ is a delay phase difference of the second sensor signal relative to the second driving signal. Hereinafter, the phase difference η₂ will be referred to as a “second delay phase difference η₂”.

The first angle detection signal S1c generated by the first signal processing unit 51A is fed back to the first driving signal generation unit 50A. The first phase shift unit 52A shifts the phase of the driving voltage waveform output from the first driving signal generation unit 50A. The first phase shift unit 52A shifts the phase by, for example, 90°. In addition, the first angle detection signal S1c generated by the first signal processing unit 51A is input to the first zero cross pulse output unit 53A.

The second angle detection signal S2c generated by the second signal processing unit 51B is fed back to the second driving signal generation unit 50B. The second phase shift unit 52B shifts the phase of the driving voltage waveform output from the second driving signal generation unit 50B. The second phase shift unit 52B shifts the phase by, for example, 90°. In addition, the second angle detection signal S2c generated by the second signal processing unit 51B is input to the second zero cross pulse output unit 53B.

The first zero cross pulse output unit 53A generates a first zero cross pulse ZC1 based on the first angle detection signal S1c input from the first signal processing unit 51A. The first zero cross pulse output unit 53A is composed of a zero cross detection circuit.

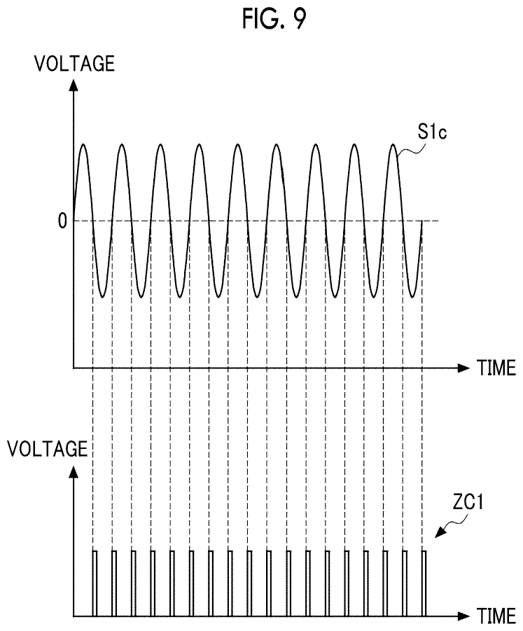

As shown in FIG. 9, the first zero cross pulse output unit 53A generates the first zero cross pulse ZC1 at a timing at which the first angle detection signal S1c, which is an AC signal, crosses zero volt. The first zero cross pulse output unit 53A inputs the generated first zero cross pulse ZC1 to the light source driving unit 55.

The second zero cross pulse output unit 53B generates a second zero cross pulse ZC2 based on the second angle detection signal S2c input from the second signal processing unit 51B. The second zero cross pulse output unit 53B is composed of a zero cross detection circuit.

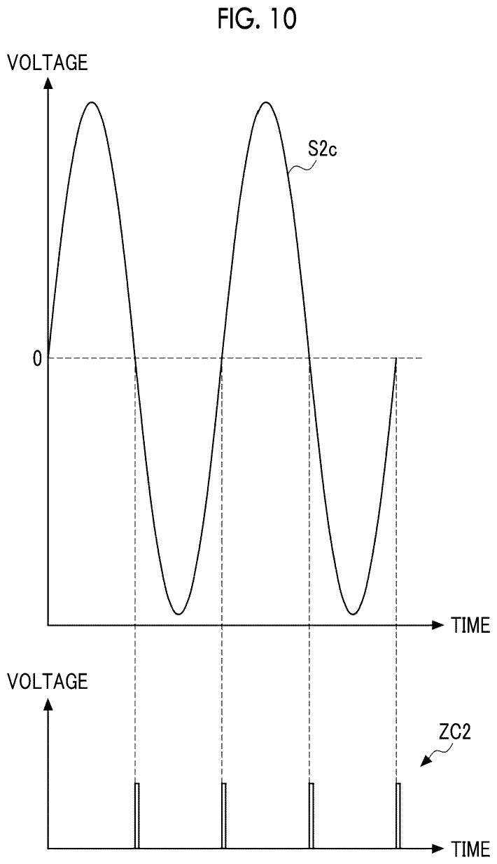

As shown in FIG. 10, the second zero cross pulse output unit 53B generates the second zero cross pulse ZC2 at a timing at which the second angle detection signal S2c, which is an AC signal, crosses zero volt. The second zero cross pulse output unit 53B inputs the generated second zero cross pulse ZC2 to the light source driving unit 55.

The light source driving unit 55 drives the light source 3 based on, for example, drawing data supplied from the outside of the image drawing system 10 and stored in the memory 56. In addition, the light source driving unit 55 controls an irradiation timing of the laser light from the light source 3 such that the irradiation timing is synchronized with the first zero cross pulse ZC1 and with the second zero cross pulse ZC2.

The memory 56 stores scanning information input from the outside in addition to the drawing data. The scanning information includes the above-described frequency ratio H and phase difference φ.

The delay phase difference control unit 54 includes a setting change unit 54A and a delay phase difference measurement unit 54B. The setting change unit 54A sets the first driving frequency f_{d1} and the second driving frequency f_{d2} that satisfy the frequency ratio H included in the scanning information stored in the memory 56 to the first driving signal generation unit 50A and the second driving signal generation unit 50B, respectively. In addition, the setting change unit 54A sets the phase difference φ included in the scanning information stored in the memory 56 to the first driving signal generation unit 50A and the second driving signal generation unit 50B.

The first driving signal generation unit 50A and the second driving signal generation unit 50B generate and output a first driving signal and a second driving signal that satisfy the set first driving frequency f_{d1}, second driving frequency f_{d2}, and phase difference φ. As a result, the surface to be scanned 6 is scanned with the light beam L reflected by the mirror portion 20 such that a Lissajous waveform that satisfies the frequency ratio H and the phase difference φ included in the scanning information is drawn.

As described above, in order to suppress the decrease in the maximum deflection angle of the mirror portion 20, it is preferable that the first driving frequency f_{d1} and the second driving frequency f_{d2} are set to values close to the first resonance frequency and the second resonance frequency, respectively, but the first resonance frequency and the second resonance frequency fluctuate due to a change in temperature or the like. For example, spring constants of the first support portion 21 and the second support portion 23 change due to a change in temperature or the like, and the first resonance frequency and the second resonance frequency fluctuate.

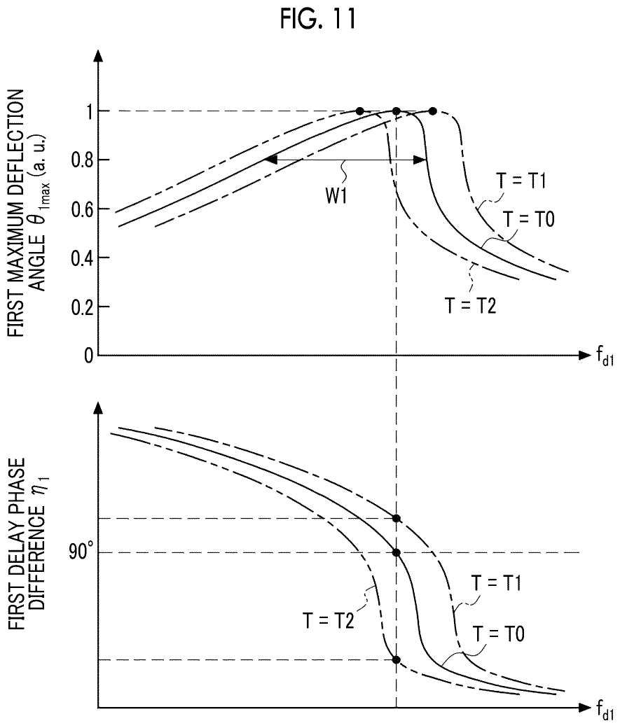

FIG. 11 shows an example of frequency characteristics of the mirror portion 20 around the first axis a₁. FIG. 11 shows changes in first maximum deflection angle θ₁ₘₐₓ and first delay phase difference η₁ with respect to the first driving frequency f_{d1}. The first driving frequency f_{d1} at which the first maximum deflection angle θ₁ₘₐₓ is maximized is the first resonance frequency, and, in this case, the first delay phase difference η₁ is 90°. In addition, FIG. 11 shows a change in frequency characteristics in a case where an environmental temperature T of the MMD 4 is changed to T0, T1, and T2. Here, it is assumed that T1<T0<T2.

In a case where the environmental temperature changes while the first driving frequency f_{d1} is kept constant, the first resonance frequency changes and the first delay phase difference η₁ changes. Specifically, in a case where the environmental temperature decreases while the first driving frequency f_{d1} is kept constant, the first resonance frequency increases, and the first delay phase difference η₁ changes from 90° in an increasing direction. On the other hand, in a case where the environmental temperature increases while the first driving frequency f_{d1} is kept constant, the first resonance frequency decreases, and the first delay phase difference η₁ changes from 90° in a decreasing direction.

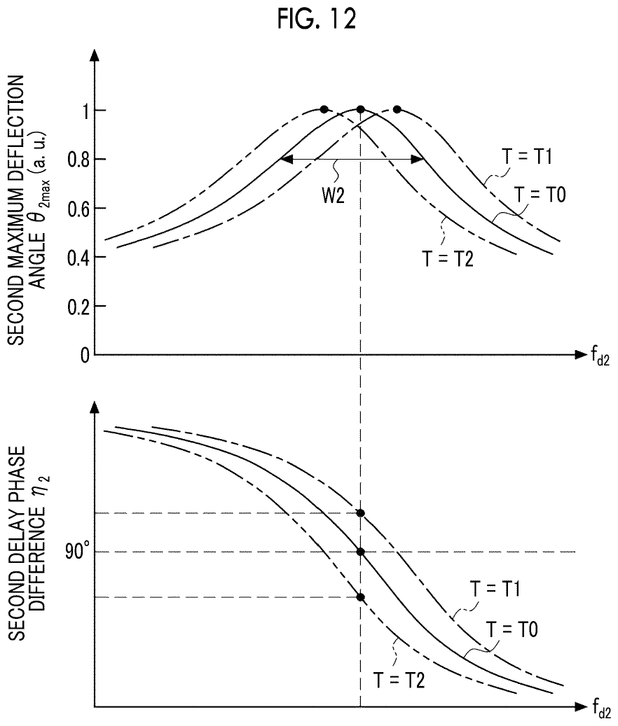

FIG. 12 shows an example of frequency characteristics of the mirror portion 20 around the second axis a₂. FIG. 12 shows changes in second maximum deflection angle θ₂ₘₐₓ and second delay phase difference η₂ with respect to the second driving frequency f_{d2}. The second driving frequency f_{d1} at which the second maximum deflection angle θ₂ₘₐₓ is maximized is the second resonance frequency, and, in this case, the second delay phase difference η₂ is 90°. In addition, FIG. 12 shows a change in frequency characteristics in a case where an environmental temperature T of the MMD 4 is changed to T0, T1, and T2. Here, it is assumed that T1<T0<T2.

In a case where the environmental temperature changes while the second driving frequency f_{d2} is kept constant, the second resonance frequency changes and the second delay phase difference η₂ changes. Specifically, in a case where the environmental temperature decreases while the second driving frequency f_{d2} is kept constant, the second resonance frequency increases, and the second delay phase difference η₂ changes from 90° in an increasing direction. On the other hand, in a case where the environmental temperature increases while the second driving frequency f_{d2} is kept constant, the second resonance frequency decreases, and the second delay phase difference η₂ changes from 90° in a decreasing direction.

In FIG. 11, W1 indicates a frequency bandwidth of the deflection angle around the first axis a₁ with respect to the first driving frequency f_{d1}. In FIG. 12, W2 indicates a frequency bandwidth of the deflection angle around the second axis a₂ with respect to the second driving frequency f_{d2}. In the present embodiment, the frequency bandwidth is defined as a width between two driving frequencies at which the maximum deflection angle is 80% of the maximum value. Without being limited thereto, the frequency bandwidth may be defined as a width between two driving frequencies at which the maximum deflection angle is 1/√2 times or ½ times the maximum value. In the configuration of the MMD 4 of the present embodiment, the frequency bandwidth of the deflection angle around the second axis a₂ having a low driving frequency is narrower than the frequency bandwidth of the deflection angle around the first axis a₁ having a high driving frequency. That is, in the present embodiment, W1>W2.

In the present embodiment, the delay phase difference measurement unit 54B measures the second delay phase difference η₂ based on the second driving signals applied to the pair of second actuators 32 and the second angle detection signal output from the second signal processing unit 51B. That is, in the present embodiment, the delay phase difference control unit 54 measures the delay phase difference around the axis having a narrower frequency bandwidth between the first axis a₁ and the second axis a₂. The delay phase difference measurement unit 54B may measure the second delay phase difference η₂ based on the second driving signals applied to the pair of second actuators 32 and the second sensor signals output from the second angle detection sensors 12A and 12B. In addition, the delay phase difference measurement unit 54B may measure the second delay phase difference η₂ based on the second driving signals applied to the pair of second actuators 32 and the second zero cross pulse ZC2 output by the second zero cross pulse output unit 53B.

The setting change unit 54A determines a value of the second driving frequency f_{d2} such that the second delay phase difference η₂ is brought closer to a reference value of 90° based on the second delay phase difference η₂ measured by the delay phase difference measurement unit 54B. In addition, the setting change unit 54A determines a value of the first driving frequency f_{d1} under the condition in which the frequency ratio H is constant, based on the determined value of the second driving frequency f_{d2}. Then, the setting change unit 54A changes the first driving frequency f_{d1} and the second driving frequency f_{d2} to the respective determined values by controlling the first driving signal generation unit 50A and the second driving signal generation unit 50B.

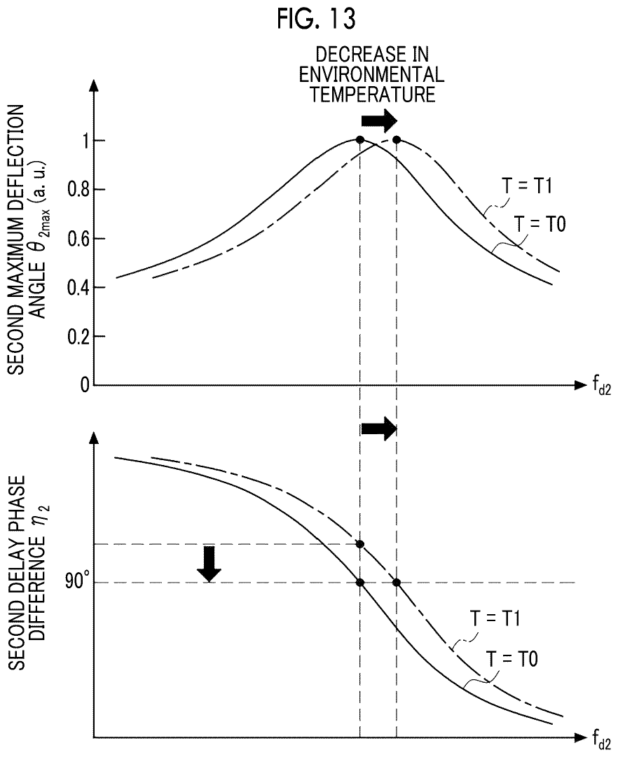

FIG. 13 conceptually shows delay phase difference control in a case where the environmental temperature is decreased. As shown in FIG. 13, in a case where the environmental temperature is decreased, the second delay phase difference η₂ is larger than the reference value, so that the second delay phase difference η₂ is changed to a lowering direction, that is, the second driving frequency f_{d2} is changed to an increasing direction. The amount of change in the second driving frequency f_{d2} is not limited to the amount corresponding to a difference between the measured value and the reference value of the second delay phase difference η₂, and may be smaller than the amount corresponding to the difference between the measured value and the reference value. In addition, the amount of change may be a constant value that does not depend on the difference between the measured value and the reference value. The reference value is not limited to 90°.

In addition, in a case of changing the first driving frequency f_{d1} and the second driving frequency f_{d2}, the setting change unit 54A may derive the greatest common divisor between the current first driving frequency f_{d1} and the current second driving frequency f_{d2}, change the first driving frequency f_{d1} in units of a value obtained by dividing the first driving frequency f_{d1} by the greatest common divisor, and change the second driving frequency f_{d2} in units of a value obtained by dividing the second driving frequency f_{d2} by the greatest common divisor.

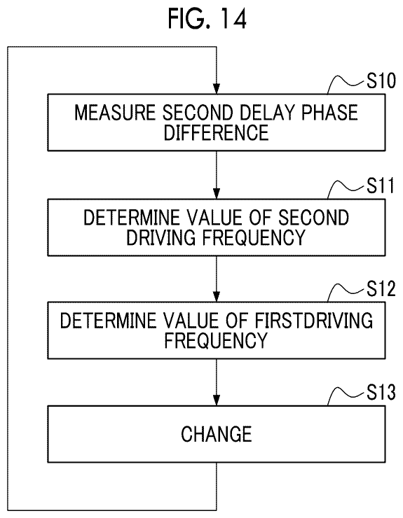

FIG. 14 shows an example of a flow of the delay phase difference control. The delay phase difference control is performed during the operation of the MMD 4. First, in step S10, the delay phase difference measurement unit 54B measures the second delay phase difference η₂. Next, in step S11, the setting change unit 54A determines a value of the second driving frequency f_{d2} such that the second delay phase difference η₂ is brought closer to the reference value based on the measured value of the second delay phase difference η₂. Next, in step S12, the setting change unit 54A determines a value of the first driving frequency f_{d1} based on the determined value of the second driving frequency f_{d2} and the frequency ratio H. Next, in step S13, the setting change unit 54A changes the first driving frequency f_{d1} and the second driving frequency f_{d2} to the respective determined values. Steps S10 to S13 are repeatedly executed at a fixed cycle.

As described above, in the present embodiment, the delay phase difference control unit 54 changes the second driving frequency f_{d2} such that the measured value of the second delay phase difference η₂ approaches the reference value while maintaining the frequency ratio H at a constant value. Therefore, the second driving frequency f_{d2} is maintained in the vicinity of the second resonance frequency. As a result, the decrease in the second maximum deflection angle θ₂ₘₐₓ is suppressed.

The first driving frequency f_{d1} is changed depending on the second driving frequency f_{d2} and the frequency ratio H, but, in the present embodiment, the delay phase difference control is performed on the second axis a₂ having a low driving frequency and a narrow frequency bandwidth, so that, in addition to the decrease in the second maximum deflection angle θ₂ₘₐₓ, the decrease in the first maximum deflection angle θ₁ₘₐₓ is suppressed.

### Experimental Example

In order to confirm the effects of the first embodiment, the present applicant carried out Experiments 1 to 3 using an MMD 4 having the same configuration. In Experiment 1, the delay phase difference control was performed on the second axis a₂ having a narrow frequency bandwidth. In Experiment 2, the delay phase difference control was performed on the first axis a₁ having a wide frequency bandwidth. In Experiment 3, no delay phase difference control was performed for any axis. In Experiments 1 to 3, the first maximum deflection angle θ₁ₘₐₓ and the second maximum deflection angle θ₂ₘₐₓ were measured while changing the environmental temperature T in a range of 25° C. to 35° C. over time.

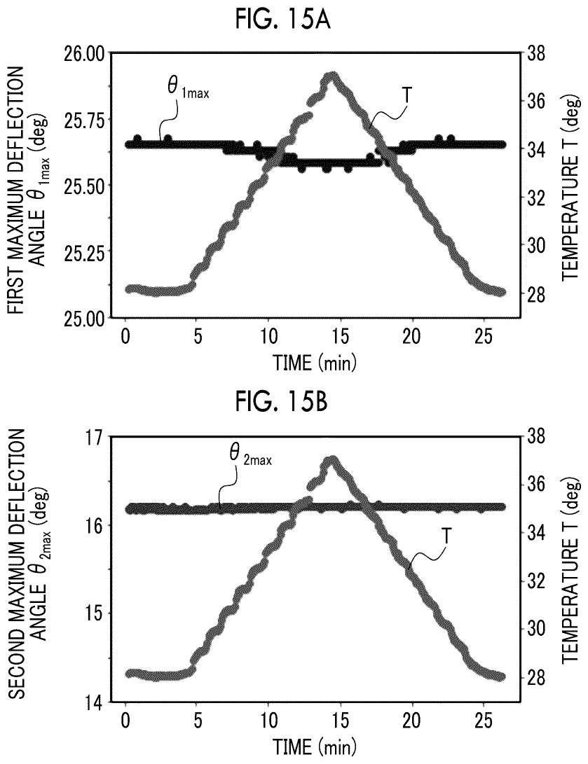

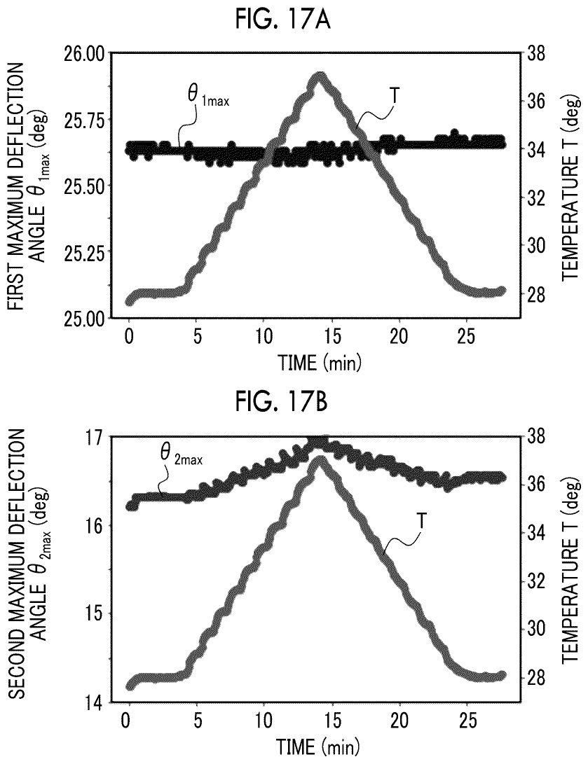

FIGS. 15A and 15B to FIGS. 17A and 17B show results of Experiments 1 to 3, respectively. According to FIGS. 15A and 15B to FIGS. 17A and 17B, it can be seen that the decreases in the first maximum deflection angle θ₁ₘₐₓ and the second maximum deflection angle θ₂ₘₐₓ are suppressed by performing the delay phase difference control.

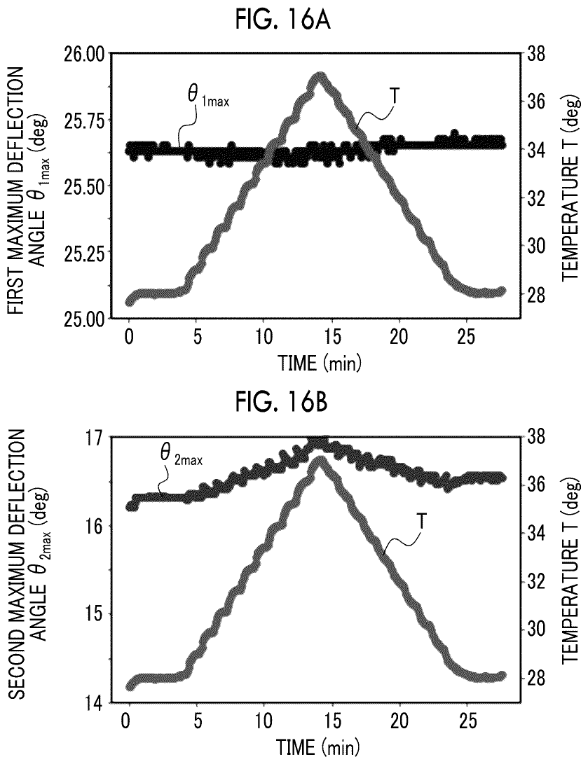

In addition, as shown in FIGS. 16A and 16B, in a case where the delay phase difference control is performed on the first axis a₁ having a wide frequency bandwidth, the decrease in the first maximum deflection angle θ₁ₘₐₓ is suppressed, but the decrease in the second maximum deflection angle θ₂ₘₐₓ is not sufficiently suppressed. On the other hand, as shown in FIGS. 15A and 15B, it can be seen that, in a case where the delay phase difference control is performed on the second axis a₂ having a narrow frequency bandwidth, the decrease in the first maximum deflection angle θ₁ₘₐₓ is suppressed in addition to the decrease in the second maximum deflection angle θ₂ₘₐₓ.

### Second Embodiment

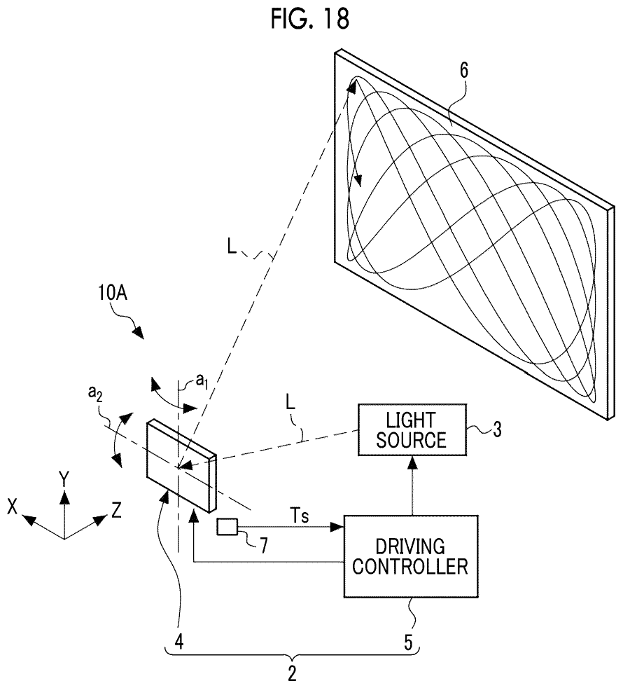

First, a configuration of an image drawing system 10A according to a second embodiment will be described with reference to FIG. 18. As shown in FIG. 18, the image drawing system 10A comprises a temperature sensor 7 in addition to the configuration of the image drawing system 10 according to the first embodiment. The temperature sensor 7 is disposed in the vicinity of the MMD 4. The temperature sensor 7 detects the environmental temperature of the MMD 4 and outputs a detected value Ts of the environmental temperature to a driving controller 5.

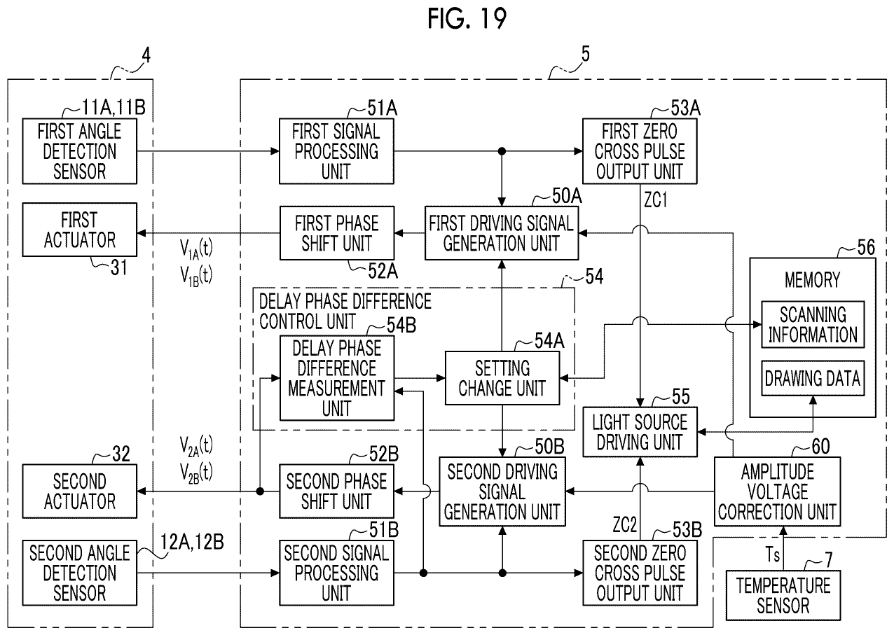

A functional configuration of the driving controller 5 according to the second embodiment will be described with reference to FIG. 19. As shown in FIG. 19, in the present embodiment, the driving controller 5 includes an amplitude voltage correction unit 60 in addition to the configuration of the driving controller 5 according to the first embodiment. The amplitude voltage correction unit 60 receives the detected value Ts of the environmental temperature from the temperature sensor 7.

The amplitude voltage correction unit 60 corrects an amplitude voltage A₁ of the first driving signal generated by the first driving signal generation unit 50A and an amplitude voltage A₂ of the second driving signal generated by the second driving signal generation unit 50B based on the detected value Ts. Specifically, the amplitude voltage correction unit 60 corrects the amplitude voltage A₁ based on Equation (1) and corrects the amplitude voltage A₂ based on Equation (2).

$${A}_{1} = {A}_{10} + {C}_{1} \times ( Ts - {T}_{0} ) \qquad ( 1 )$$

$${A}_{2} = {A}_{20} + {C}_{2} \times ( Ts - {T}_{0} ) \qquad ( 2 )$$

Here, T₀ is a reference temperature. A₁₀ is a reference amplitude voltage of the first driving signal. C₁ is a correction coefficient. A₂₀ is a reference amplitude voltage of the second driving signal. C₂ is a correction coefficient. For example, T₀=28° C., C₁=0.1 V/° C., and C₂=−0.01 V/° C.

The operation of the image drawing system 10A is the same as the operation of the image drawing system 10 according to the first embodiment, except that the amplitude voltage correction unit 60 corrects the amplitude voltages A₁ and A₂ based on the detected value Ts of the environmental temperature.

By correcting the amplitude voltages A₁ and A₂ based on the detected value Ts of the environmental temperature, it is possible to suppress the decreases in the first maximum deflection angle θ₁ₘₐₓ and the second maximum deflection angle θ₂ₘₐₓ even in a case where the environmental temperature is greatly changed.

### Experimental Example

In order to confirm the effects of the second embodiment, the present applicant carried out Experiments 4 to 6 using an MMD 4 having the same configuration. In Experiment 4, in addition to the delay phase difference control for the second axis a₂ having a narrow frequency bandwidth, the amplitude voltages A₁ and A₂ were corrected based on the detected value Ts of the environmental temperature. In Experiment 5, only the delay phase difference control was performed on the second axis a₂ having a narrow frequency bandwidth. In Experiment 6, the delay phase difference control and the correction of the amplitude voltages A₁ and A₂ were not performed. In Experiments 4 to 6, the first maximum deflection angle θ₁ₘₐₓ and the second maximum deflection angle θ₂ₘₐₓ were measured while changing the environmental temperature T in a range of 15° C. to 35° C. over time. In addition, T₀=28° C., C₁=0.1 V/° C., and C₂=−0.01 V/° C.

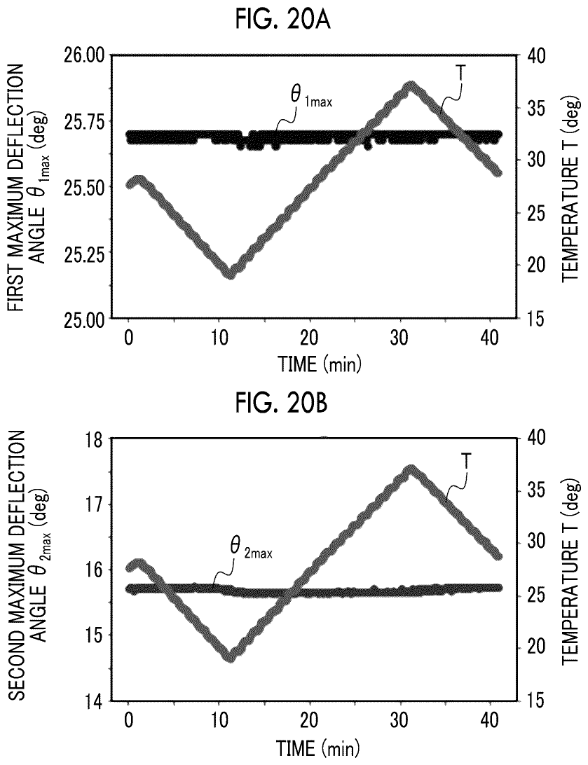

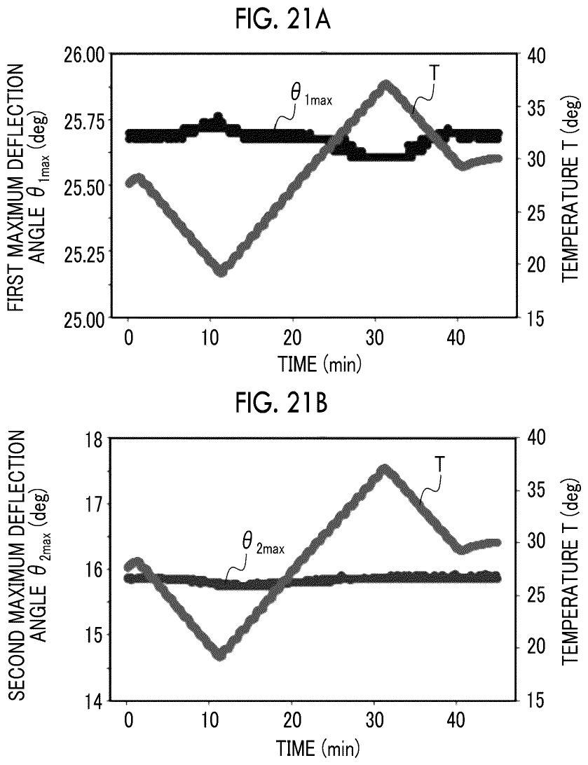

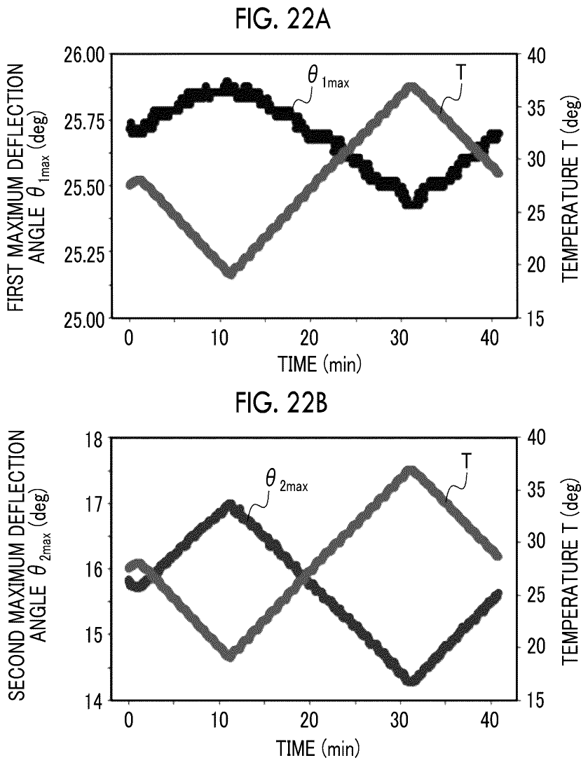

FIGS. 20A and 20B to FIGS. 22A and 22B show results of Experiments 4 to 6, respectively. According to FIGS. 20A and 20B to FIGS. 22A and 22B, it can be seen that the decreases in the first maximum deflection angle θ₁ₘₐₓ and the second maximum deflection angle θ₂ₘₐₓ are suppressed by performing the delay phase difference control for the second axis a₂ having a narrow frequency bandwidth. Further, it can be seen that the decreases in the first maximum deflection angle θ₁ₘₐₓ and the second maximum deflection angle θ₂ₘₐₓ is further suppressed by correcting the amplitude voltages A₁ and A₂ based on the detected value Ts of the environmental temperature, in addition to the delay phase difference control for the second axis a₂ having a narrow frequency bandwidth.

### Modification Example

Hereinafter, various modification examples of the first and second embodiments will be described.

In each of the above-described embodiments, the delay phase difference control is performed on the second axis a₂ having a narrow frequency bandwidth, but the delay phase difference control may be performed on the first axis a₁ having a wide frequency bandwidth. That is, the delay phase difference measurement unit 54B may measure the first delay phase difference η₁. In this case, the setting change unit 54A determines a value of the first driving frequency f_{d1} such that the first delay phase difference η₁ is brought closer to the reference value, and determines a value of the second delay phase difference η₂ based on the determined value of the first driving frequency f_{d1} and the frequency ratio H.

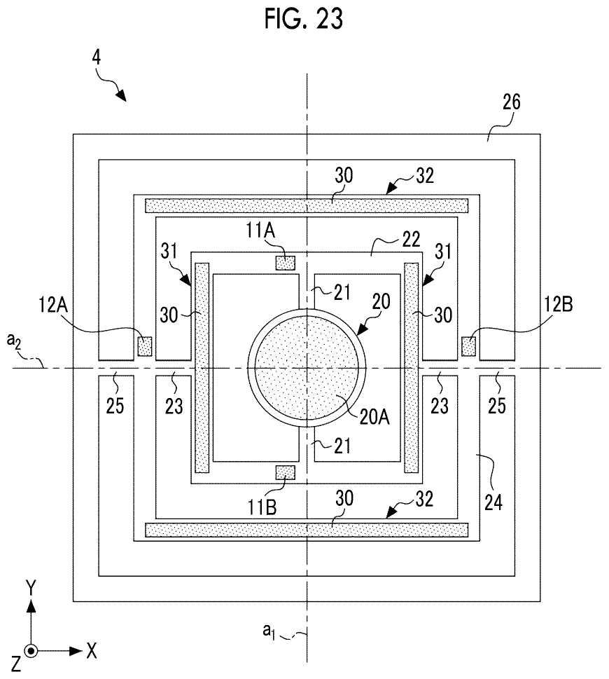

In addition, in each of the above-described embodiments, a case where the first angle detection sensors 11A and 11B are disposed at positions facing each other across the first axis a₁ has been described, the present disclosure is not limited to this. For example, as shown in FIG. 23, the first angle detection sensors 11A and 11B may be disposed at positions facing each other across the second axis a₂. In the example of FIG. 23, the first angle detection sensors 11A and 11B are disposed on the first movable frame 22 in the vicinity of the first support portion 21. The first angle detection sensor 11A is disposed in the vicinity of the first support portion 21 connected to one side of the mirror portion 20. The first angle detection sensor 11B is disposed in the vicinity of the first support portion 21 connected to the other side of the mirror portion 20. Therefore, the first angle detection sensors 11A and 11B are disposed at positions facing each other across the second axis a₂ and facing each other across the mirror portion 20. In addition, the first angle detection sensors 11A and 11B are disposed at positions that are shifted in the same direction (in the example in FIG. 23, the −X direction) from the first axis a₁.

In a case where the first angle detection sensors 11A and 11B are disposed at positions facing each other across the first axis a₁ as in each of the above-described embodiments, vibration noise can be removed by subtracting one of the output signals of both of the first angle detection sensors 11A and 11B from the other. On the other hand, in a case where the first angle detection sensors 11A and 11B are disposed at positions facing each other across the second axis a₂ as in each of the above-described embodiments, vibration noise can be removed by adding the output signals of both of the first angle detection sensors 11A and 11B.

In addition, in each of the above-described embodiments, a case where the second angle detection sensors 12A and 12B are disposed at positions facing each other across the second axis a₂ has been described, the present disclosure is not limited to this. For example, as shown in FIG. 23, the second angle detection sensors 12A and 12B may be disposed at positions facing each other across the first axis a₁. In the example of FIG. 23, the second angle detection sensors 12A and 12B are disposed on the second movable frame 24 in the vicinity of the second support portion 23. The second angle detection sensor 12A is disposed in the vicinity of the second support portion 23 connected to one side of the first movable frame 22. The second angle detection sensor 12B is disposed in the vicinity of the second support portion 23 connected to the other side of the first movable frame 22. Therefore, the second angle detection sensors 12A and 12B are disposed at positions facing each other across the first axis a₁ and facing each other across the mirror portion 20 and the first movable frame 22. In addition, the second angle detection sensors 12A and 12B are disposed at positions that are shifted in the same direction (in the example in FIG. 23, the +Y direction) from the second axis a₂.

In a case where the second angle detection sensors 12A and 12B are disposed at positions facing each other across the second axis a₂ as in each of the above-described embodiments, vibration noise can be removed by subtracting one of the output signals of both of the second angle detection sensors 12A and 12B from the other. On the other hand, in a case where the second angle detection sensors 12A and 12B are disposed at positions facing each other across the first axis a₁ as in each of the above-described embodiments, vibration noise can be removed by adding the output signals of both of the second angle detection sensors 12A and 12B.

In addition, in each of the above-described embodiments, the first angle detection sensors 11A and 11B and the second angle detection sensors 12A and 12B are provided in the MMD 4, but one first angle detection sensor and one second angle detection sensor may be provided in the MMD 4. In this case, the delay phase difference measurement unit 54B measures the second delay phase difference η₂ based on the second driving signal and the second sensor signal output from the second angle detection sensor. The delay phase difference measurement unit 54B may measure the first delay phase difference η₁ based on the first driving signal and the first sensor signal output from the first angle detection sensor. In addition, the configuration of the MMD 4 shown in each of the above-described embodiments is an example. The configuration of the MMD 4 can be modified in various ways. For example, the pair of first actuators 31 that cause the mirror portion 20 to swing around the first axis a₁ may be disposed on the second movable frame 24, and the pair of second actuators 32 that cause the mirror portion 20 to swing around the second axis a₂ may be disposed on the first movable frame 22.

In addition, in each of the above-described embodiments, an axis passing through the first support portion 21 is defined as the first axis a₁, and an axis passing through the second support portion 23 is defined as the second axis a₂. Alternatively, the axis passing through the first support portion 21 may be defined as the second axis a₂, and the axis passing through the second support portion 23 may be defined as the first axis a₁.

The hardware configuration of the driving controller 5 can be variously modified. The driving controller 5 can be configured using at least one of an analog operation circuit or a digital operation circuit. The driving controller 5 may be composed of one processor or may be composed of a combination of two or more processors of the same type or different types. The processor includes, for example, a central processing unit (CPU), a programmable logic device (PLD), and a dedicated electric circuit. As is well known, the CPU is a general-purpose processor that executes software (program) stored in a memory to function as various processing units. The PLD is a processor such as a field programmable gate array (FPGA) whose circuit configuration can be changed after manufacture. The dedicated electric circuit is a processor that has a dedicated circuit configuration designed to perform a specific process, such as an application specific integrated circuit (ASIC).

It is possible to ascertain the following technologies by the above description.

### Supplementary Note 1

An optical scanning device comprising:
a mirror portion that reflects an incidence ray;
a pair of first actuators that causes the mirror portion to swing around a first axis;
a pair of second actuators that causes the mirror portion to swing around a second axis intersecting the first axis;
a first angle detection sensor that outputs a first sensor signal corresponding to a deflection angle of the mirror portion around the first axis;
a second angle detection sensor that outputs a second sensor signal corresponding to a deflection angle of the mirror portion around the second axis; and
a processor that applies a first driving signal having a first driving frequency to the pair of first actuators and applies a second driving signal having a second driving frequency to the pair of second actuators,
in which the processor changes the second driving frequency such that a delay phase difference of the second sensor signal relative to the second driving signal is brought closer to a reference value while maintaining a frequency ratio, which is a ratio between the first driving frequency and the second driving frequency, at a constant value.

### Supplementary Note 2

The optical scanning device according to Supplementary Note 1,
in which the processor
   determines a value of the second driving frequency such that the delay phase difference is brought closer to the reference value,
   determines a value of the first driving frequency based on the determined value of the second driving frequency and the frequency ratio, and
   changes the first driving frequency and the second driving frequency to the respective determined values.

### Supplementary Note 3

The optical scanning device according to Supplementary Note 1 or 2,
in which the second driving frequency is lower than the first driving frequency.

### Supplementary Note 4

The optical scanning device according to any one of Supplementary Notes 1 to 3,
in which a frequency bandwidth of the deflection angle around the second axis with respect to the second driving frequency is narrower than a frequency bandwidth of the deflection angle around the first axis with respect to the first driving frequency.

### Supplementary Note 5

The optical scanning device according to any one of Supplementary Notes 1 to 4,
in which the reference value is 90°.

### Supplementary Note 6

The optical scanning device according to any one of Supplementary Notes 1 to 5, further comprising:
a temperature sensor that detects an environmental temperature and outputs a detected value,
in which the processor corrects an amplitude voltage of the first driving signal and an amplitude voltage of the second driving signal based on the detected value.

### Supplementary Note 7

An image drawing system comprising:
the optical scanning device according to any one of Supplementary Notes 1 to 6; and
a light source that irradiates the mirror portion with a light beam.

What is claimed is:

1. An optical scanning device comprising:
a mirror portion that reflects an incidence ray;
a pair of first actuators that causes the mirror portion to swing around a first axis;
a pair of second actuators that causes the mirror portion to swing around a second axis intersecting the first axis;
a first angle detection sensor that outputs a first sensor signal corresponding to a deflection angle of the mirror portion around the first axis;
a second angle detection sensor that outputs a second sensor signal corresponding to a deflection angle of the mirror portion around the second axis; and
a processor that applies a first driving signal having a first driving frequency to the pair of first actuators and applies a second driving signal having a second driving frequency to the pair of second actuators,
wherein the processor changes the second driving frequency such that a delay phase difference of the second sensor signal relative to the second driving signal is brought closer to a reference value while maintaining a frequency ratio, which is a ratio between the first driving frequency and the second driving frequency, at a constant value.

2. The optical scanning device according to claim 1,
wherein the processor
determines a value of the second driving frequency such that the delay phase difference is brought closer to the reference value,
determines a value of the first driving frequency based on the determined value of the second driving frequency and the frequency ratio, and
changes the first driving frequency and the second driving frequency to the respective determined values.

3. The optical scanning device according to claim 1,
wherein the second driving frequency is lower than the first driving frequency.

4. The optical scanning device according to claim 3,
wherein a frequency bandwidth of the deflection angle around the second axis with respect to the second driving frequency is narrower than a frequency bandwidth of the deflection angle around the first axis with respect to the first driving frequency.

5. The optical scanning device according to claim 1,
wherein the reference value is 90°.

6. The optical scanning device according to claim 1, further comprising:
a temperature sensor that detects an environmental temperature and outputs a detected value,
wherein the processor corrects an amplitude voltage of the first driving signal and an amplitude voltage of the second driving signal based on the detected value.

7. An image drawing system comprising:
the optical scanning device according to claim 1; and
a light source that irradiates the mirror portion with a light beam.

8. A driving method of a mirror device that includes a mirror portion that reflects an incidence ray, a pair of first actuators that causes the mirror portion to swing around a first axis, a pair of second actuators that causes the mirror portion to swing around a second axis intersecting the first axis, a first angle detection sensor that outputs a first sensor signal corresponding to a deflection angle of the mirror portion around the first axis, and a second angle detection sensor that outputs a second sensor signal corresponding to a deflection angle of the mirror portion around the second axis, the driving method comprising:
causing a processor to
apply a first driving signal having a first driving frequency to the pair of first actuators,
apply a second driving signal having a second driving frequency to the pair of second actuators, and
change the second driving frequency such that a delay phase difference of the second sensor signal relative to the second driving signal is brought closer to a reference value while maintaining a frequency ratio, which is a ratio between the first driving frequency and the second driving frequency, at a constant value.
